(19) United States
(12) Patent Application Publication
(10) Pub. No.: US 2003/0030328 A1
(43) Pub. Date: Feb. 13, 2003

(54) Power distribution apparatus and intermediate connector therein

(75) Inventors: Yasuhiro Tamai, Shizuoka (JP); Tetsuya Hasegawa, Shizuoka (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/192,148

(22) Filed: Jul. 11, 2002

(30) Foreign Application Priority Data
Aug. 7, 2001 (JP) P 2001-239827

(51) Int. Cl. H02J 1/00

(52) U.S. Cl. 307/82

(57) ABSTRACT

A power distributing system is provided with improved efficiency in converting a voltage of a power source and also reduced heat-generation. The power distributing apparatus 1 includes a power source part 4 generating a power source of a high voltage and a plurality of electronic control units 7 to which the power source part 4 supplies the power source of the high voltage through respective power lines 5, 8. The power lines 8 from the power source part 4 are connected with the electronic control units 7 through the intermediary of a plurality of intermediate connectors 9. Each intermediate connector 9 has a built-in converter 13 for converting the high voltage of 42V into an intermediate voltage of 12V. In each electronic control unit 7, a series regulator 14 is arranged to convert the intermediate voltage of 12V into a load voltage of 5V.

### BACKGROUND OF THE INVENTION

1. Field of the Invention

The present invention relates to a power distribution apparatus mounted on a vehicle etc. to distribute electrical power to a variety of loads of the vehicle and also relates to intermediate connectors used in the power distribution apparatus.

2. Description of the Related Art

In the conventional vehicle adopting a power source of 14V (voltage), the power distribution apparatus includes an electrical connection box to which high-voltage power is supplied from the power source, and a plurality of electronic control units connected to the electrical connection box through power lines, the electronic control units each having a built-in series regulator to which the high-voltage power is distributed. In operation, the high-voltage power from the electrical connection box is converted into low-voltage power by the series regulators in the electronic control units. Then, the so-converted low-voltage is supplied to a plurality of loads connected to respective electronic control units.

Meanwhile, recently, there has been developed a “high-voltage” vehicle using a voltage of 42V, which is loaded with a motor generator effective to reduction in fuel consumption. However, if the above-mentioned power distribution apparatus is applied to such a high-voltage vehicle, then the power distribution apparatus exhibits a remarkably-deteriorated conversion efficiency and also a great heat generation. That is, if the vehicle adopts a power source of 14V and further a voltage for each load is equal to 5V, then the series regulators each has an efficiency of 35.7% [=(14−5)/14]. While, if the vehicle adopts a power source of 42V and further a voltage for each load is equal to 5V, the series regulator will have an efficiency of 11.9% [=(42−5)/42].

In connection, Japanese Patent Application Laid-open No. 10-84626 discloses another conventional power distributing apparatus where the electrical connection box is supplied with high-voltage power from the power source and also provided with a voltage converter which converts a high voltage into a low voltage (5V), so that the resultant low-voltage power is supplied to respective electronic control units.

In this power distributing apparatus, however, there arises a problem of voltage drop in case of the power supply against electrical loads far from the voltage converter, requiring respective power lines for the electrical loads to be shielded. In addition, the voltage converter is required to meet requirements of the most severe electrical load in terms of converted voltage and temperature characteristics, causing the production cost of the apparatus to be elevated. Since the converter is apt to output with power fluctuations due to gain and loss in load currents, it is difficult to supply the plurality of loads with accurate powers.

### SUMMARY OF THE INVENTION

Under the circumstances, it is therefore an object of the present invention to provide a power distributing system which has an improved efficiency to convert a voltage of a power source and which is not accompanied with great heat-generation.

The object of the present invention described above can be accomplished by a power source part generating a power of a high voltage;

a plurality of power distributing parts to which the power source part supplies the power of the high voltage through respective power lines, each of the power distributing parts being adapted to supply a load with a load voltage;

a plurality of intermediate connectors through which the power lines from the power source part are connected with the power distributing parts respectively; and

a plurality of converters disposed in the intermediate connectors respectively thereby to each convert the high voltage into an intermediate voltage lower than the high voltage.

Since the converters each having an improved conversion efficiency in comparison with a regulator convert the high voltage into the intermediate voltage, the power distributing apparatus can be provided with improved conversion efficiency for a voltage of the power and without great heat-generation. Furthermore, since the high voltage of the power source part is converted to the intermediate voltage by the intermediate connectors, there is no need to consider a voltage drop from the power source part to the power distributing parts, so that it is unnecessary to form the power lines by shield lines.

According to the second aspect of the invention, in the above power distributing apparatus, the intermediate voltage is higher than the load voltage and the power distributing parts are respectively provided with series regulators each of which converts the intermediate voltage into the load voltage.

Owing to the provision of the series regulators capable of providing load voltage with high accuracy, the converters are not required to provide outputs with severe accuracy. Furthermore, each of the series regulators has only to possess temperature characteristics and accuracy necessary for a load in charge of the corresponding power distributing part.

According to the third aspect of the invention, in the power distributing apparatus of the second aspect, the intermediate voltage higher than the load voltage is equal to a voltage that a general purpose low-voltage vehicle supplies through a power source part thereof.

Then, it becomes possible to divert electronic control units for the general purpose low-voltage vehicle to the power distributing apparatus.

According to the fourth aspect of the invention, in the power distributing apparatus of the second aspect, the intermediate voltage higher than the load voltage is equal to a voltage for driving a general purpose electronic control unit.

Then, there is no need to provide any power line for driving the electronic control unit between the power source part and the electronic control units.

According to the fifth aspect of the invention, in the power distributing apparatus of the invention, the intermediate voltage is equal to the load voltage.

In this case, there is no need to provide a series regulator in each of the power distributing parts.

According to the sixth aspect of the invention, the above power distributing apparatus of the invention further comprises a plurality of power-line side connectors which are connected with the power source part through the power lines and a plurality of power-distributing side connectors which are disposed in the power distributing parts respectively. In connection, a distance between adjacent terminals of each of the power-line side connectors and also between adjacent terminals on an input side of each of the intermediate connectors is larger than a distance between adjacent terminals of each of the power-distributing side connectors and also between adjacent terminals on an output side of each of the intermediate connectors.

With establishment of the above relationship in distance, it is possible to prevent an occurrence of arcs.

According to the seventh aspect of the invention, in the power distributing apparatus of the sixth aspect, each of the intermediate connectors is provided with a mechanism which would make impossible to connect the corresponding intermediate connector with the corresponding power-distributing side connector unless the corresponding intermediate connector is connected with the corresponding power-line side connector.

Owing to the provision of the above mechanism, it is possible to prevent the occurrence of arcs etc. caused by short-circuit even when adopting general and non-insulating type converters as the converters, whereby the safety in operation can be ensured.

According to the eighth aspect of the invention, in the power distributing apparatus of the seventh aspect, the mechanism includes a connector-transferring part which is movably disposed in the intermediate connector to be engageable with both of the power-line side connector and the power-distributing side connector and which is provided with engagement pieces which allow the intermediate connector to engage with the power-distributing side connector upon engagement of the connector-transferring part with the power-line side connector.

According to the present invention, there is also provided an intermediate connector for a power distributing apparatus, disposed between a power source part thereof, the power source part generating a power of a high voltage, and a power distributing part of the power distributing apparatus, the power distributing part being adapted to supply a load with a load voltage. The intermediate connector includes a built-in converter for converting the high voltage of the power source part into an intermediate voltage lower than the high voltage.

In the above intermediate connector, since a high voltage is converted into an intermediate voltage by the converter having an improved conversion efficiency in comparison with a regulator, it is possible to provide a power distributing apparatus with improved conversion efficiency for a voltage of the power and without great heat-generation. Furthermore, since the high voltage of the power source part is converted to the intermediate voltage by the intermediate connector, there is no need to consider a voltage drop from the power source part to the power distributing part, so that it is unnecessary to form a power line therebetween by a shield line.

According to the tenth aspect of the invention, the power distributing apparatus of the ninth aspect further includes a power-line side connector which is connected with the power source part and a power-distributing side connector disposed in the power distributing part. Furthermore, a distance between adjacent terminals of the intermediate connector for connection with the power-line side connector is established larger than a distance between adjacent terminals of the intermediate connector for connection with the power-distributing side connector.

With establishment of the above relationship in distance, it is possible to prevent an occurrence of arcs on the “input” side of the intermediate connector, whereby the safety in operation can be ensured. Additionally, it is possible to make the output side of the intermediate connector compact and there is no need to consider a problem of high voltage with respect to materials for terminals, etc.

According to the eleventh aspect of the invention, the intermediate connector of the tenth aspect further comprises a mechanism which would make impossible to connect with the power-distributing side connector unless the intermediate connector is connected with the power-line side connector.

Owing to the provision of the above mechanism, it is possible to prevent the occurrence of arcs etc. caused by short-circuit even when adopting a general and non-insulating type converter as the converter, whereby the safety in operation can be ensured.

According to the twelfth aspect of the invention, in the intermediate connector of the eleventh aspect, the mechanism includes a connector-transferring part which is movably disposed in the intermediate connector to be engageable with both of the power-line side connector and the power-distributing side connector and which is provided with engagement pieces which allow the intermediate connector to engage with the power-distributing side connector on engagement of the connector-transferring part with the power-line side connector.

These and other objects and features of the present invention will become more fully apparent from the following description and appended claims taken in conjunction with the accompanying drawings.

### BRIEF DESCRIPTION OF THE DRAWINGS

FIG. 1 is a circuit block diagram of a power distributing apparatus in accordance with the first embodiment of the present invention;

FIG. 2 is a perspective view of an intermediate connector, a power-line side connector and a power-distributing side connector, showing the first embodiment of the invention;

FIG. 3 is a circuit block diagram plan view of the power distributing apparatus in accordance with the second embodiment of the present invention;

FIG. 4 is a circuit block diagram plan view of the power distributing apparatus in accordance with the third embodiment of the present invention;

FIG. 5 shows the concrete embodiment of the intermediate connector, the power-line side connector and the power-distributing side connector both fitted to the intermediate connector of the present invention and is a circuit diagram of the intermediate connector etc.;

FIG. 6 shows the embodiment of the intermediate connector etc. and is a structural view of the intermediate connector, the power-line side connector and the power-distributing side connector before their integration;

FIG. 7 shows the embodiment of the intermediate connector etc. and is a structural view showing a condition in the middle of engaging the power-line side connector with the intermediate connector;

FIG. 8 shows the embodiment of the intermediate connector etc. and is a structural view showing a condition that the engagement between the power-line side connector and the intermediate connector has been completed and the engagement between the power-distributing side connector and the intermediate connector is not finished yet; and

FIG. 9 shows the embodiment of the intermediate connector etc. and is a structural view showing a condition that the engagement among the power-line side connector, the power-distributing side connector and the intermediate connector has been completed.

### DESCRIPTION OF THE PREFERRED EMBODIMENT

Embodiments of the present invention will be described with reference to the drawings.

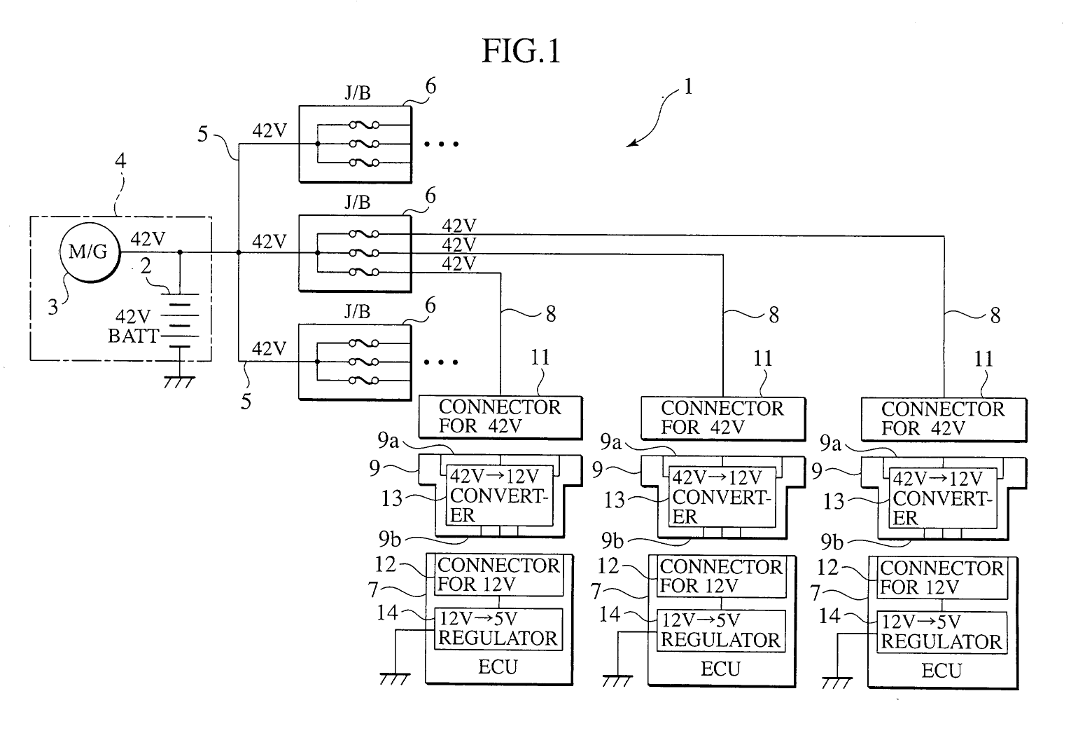

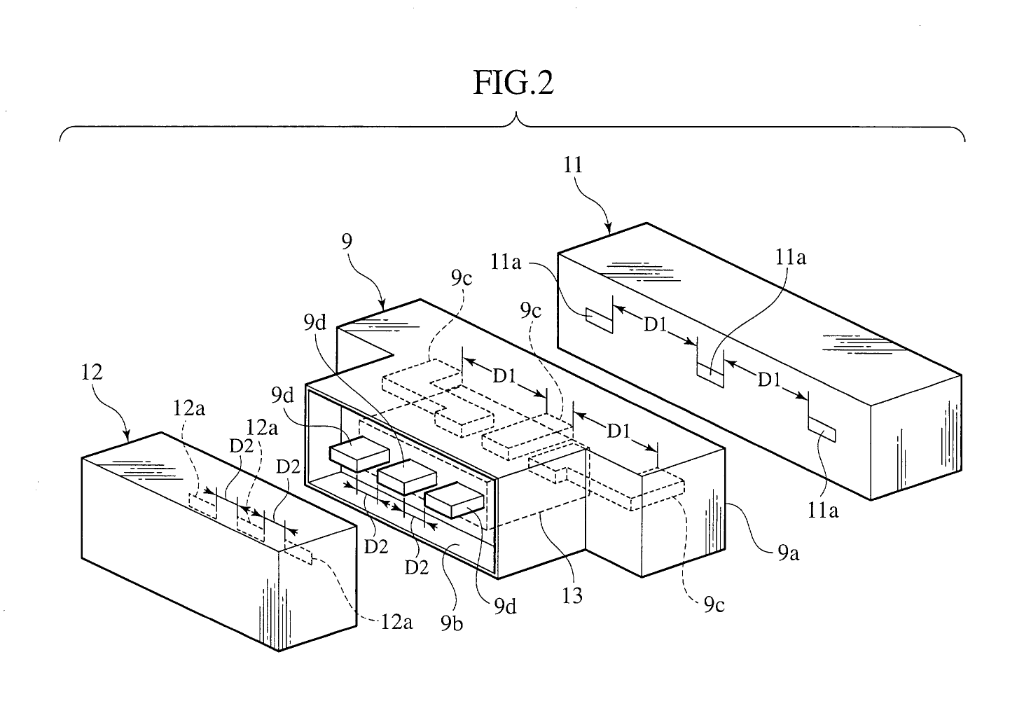

FIGS. 1 and 2 show the first embodiment of the present invention. In these figures, FIG. 1 is a circuit block diagram of a power distributing apparatus of the invention, while FIG. 2 is a perspective view showing an intermediate connector, a power-line side connector and a power-distributing side connector, as constituents of the apparatus.

As shown in FIG. 1, the power distributing apparatus 1 includes a power source part 4 formed by a chargeable/dischargeable battery 2 and a motor generator 3 that can generate power owing to the revolutions of an engine. Through respective power lines 5, the power source part 4 supplies three electrical connection boxes 6 with high-voltage power of 42V respectively. For example, these electrical connection boxes 6 are disposed in an engine room, a passenger's cabin and a trunk room, respectively. From the respective electrical connection boxes 6, power lines 8 are led toward electronic control units 7 forming a plurality of power distributing parts, respectively. Respective ends of the power lines 8 are connected to the electronic control units 7 through the intermediary of intermediate connectors 9, respectively. In detail, the power lines 8 have their ends connected to “power-line side” connectors 11. While, the electronic control units 7 are provided with “power-distributing side” connectors 12, respectively. Each of the power-line side connectors 11 is connected with an input connector part 9a of each intermediate connector 9, while each of the power-distributing side connectors 12 is connected with an output connector part 9b of each intermediate connector 9.

Each of the intermediate connectors 9 has a built-in converter 13. The converter 13 is formed by a DC (direct current)/DC converter of high conversion efficiency and converts the high-voltage power of 42V into intermediate-voltage power of 12V which is lower than the above high-voltage power and is higher than a voltage for load (5V). As shown in FIG. 2, both of the power-line side connectors 11 and the input connector part 9a of the intermediate connector 9 are provided as being connectors for 42V and a distance D1 between adjacent terminals 11a, 11a (and also 9c, 9c) is established to be relatively broad. On the other hand, both of the power-distributing side connectors 12 and the output connector part 9b of the intermediate connector 9 are provided as being connectors for 12V and a distance D2 between adjacent terminals 12a, 12a (and also 9d, 9d) is established to be relatively narrow.

In FIG. 1, the respective electronic control units 7 are connected with a plurality of loads (not shown) thereby to control their operations. Each electronic control unit 7 is provided, therein, with a series regulator 14 into which an intermediate voltage of 12V from the converter 13 is led. The series regulator 14 is formed with a known structure that stabilizes an output voltage by feedback of the changes of load voltage by means of e.g. operational amplifier and also serves the intermediate voltage of 12A into the load voltage of 5V. The output from each series regulator 14 is supplied to a plurality of loads (not shown) in charge of the corresponding electronic control unit 7.

The above-mentioned power distributing apparatus 1 operates as follows.

A high-voltage of 42V of the power source part 4 is supplied to the respective electrical connection boxes 6 through the power lines 5 and then supplied from the respective boxes 6 to the intermediate connectors 9 through the power lines 8. The high-voltage of 42V supplied to the respective intermediate connectors 9 is converted to the intermediate voltage of 12V by the converters 13 and then, the resultant intermediate voltage of 12V is supplied to the respective electronic control units 7. Subsequently, the series regulators 14 in the units 7 convert the intermediate voltage of 12V to the load voltage of 5V for the respective loads (not shown).

As mentioned above, since the power distributing apparatus 1 converts a high-voltage (42V) into an intermediate voltage (12V) owing to the converters 13 exhibiting a high conversion efficiency in comparison with regulator, it is possible to provide a system with an improved conversion efficiency for power voltage and also a reduced heat-generation. Additionally, since the high-voltage of the power source part 4 is converted to the intermediate voltage by the intermediate connectors 9 each connected with the electronic control unit 7, there is no need to consider a voltage drop from the power source part 4 to the unit 7 and further, it is not required to construct the power lines 5, 8 by shield wires. Again, because of no voltage drop between the converters 13 of the intermediate connector 9 and the electronic control units 7, it is possible to supply an electric power to the units 7 effectively.

According to the first embodiment of the invention, since the intermediate voltage is higher than the load voltage (5V) and each of the electronic control units 7 is provided with the series regulator 14 that converts the intermediate voltage into the load voltage, each of the electrical loads can be supplied with a precise load voltage produced by the regulator 14. Therefore, it is not necessary that the converters 13 each has to possess severe accuracy for supplying its output, so that ripple-absorption condensers etc. may be constructed small. Further, the series regulators 14 each has only to be equipped with temperature characteristics and accuracy required for the load in charge of the corresponding electronic control unit 7. In this view, since the converters 13 and the series regulators 14 are not required with severe requirements for outputs, it is possible to manufacture the apparatus with low price.

According to the first embodiment, since the intermediate voltage higher than the load voltage is equal to a voltage (12) that the power source unit of a popular low-voltage vehicle does supply, it is possible to divert the electronic control units for the popular low-voltage vehicle to those of the apparatus 1 of the invention, it is possible to reduce a development cost for the apparatus 1 on the assumption of the power source for the popular low-voltage vehicle in designing the electronic control unit 7.

Furthermore, owing to the above establishment of a board distance D1 between the adjacent terminals 11a, 11a (and also 9c, 9c) and a narrow distance D2 between adjacent terminals 12a, 12a (and also 9d, 9d), it is possible to prevent occurrence of arcs on the input-side of the intermediate connectors 9, contributing to the safety in operations. In addition, it is possible to miniaturize the output-side of the intermediate connectors 9 and there is no need to consider problems of high-voltage with respect to materials for the terminals 12a, 9d.

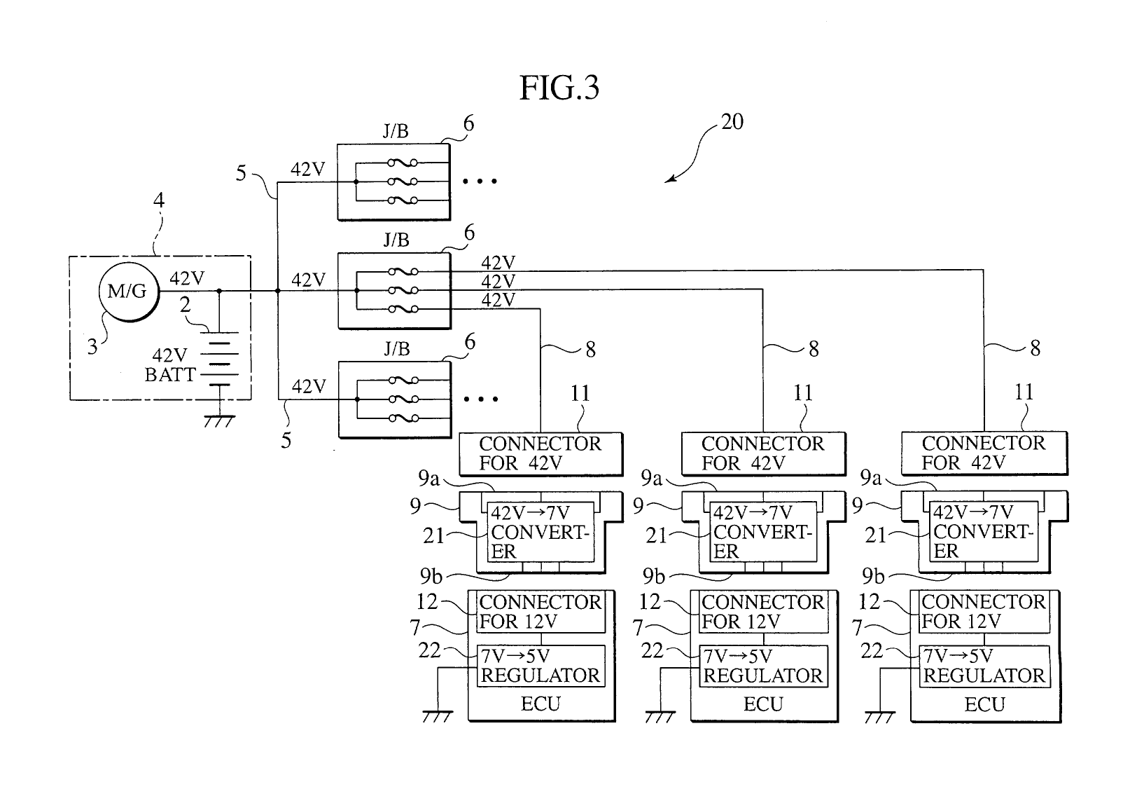

FIG. 3 is a circuit block diagram plan view of a power distributing apparatus in accordance with the second embodiment of the invention. As obvious from FIG. 3, the power distributing apparatus 20 of this embodiment differs from the same apparatus 1 of the first embodiment in that a built-in converter 21 of each intermediate connector 9 converts a high voltage of 42V of the power source part 4 to an intermediate voltage of 7V and then, a built-in series regulator 22 of each unit 7 converts the intermediate voltage of 7V to a load voltage of 5V. Since the other constitutions of this embodiment are similar to those of the first embodiment, their overlapping descriptions are eliminated. Also in FIG. 3, elements identical to those of the first embodiment are indicated with the same reference numerals respectively, for their clearness.

Both effects and operations of the apparatus of this embodiment are similar to those of the first embodiment.

In the second embodiment, the intermediate voltage has a value of 7V somewhat larger than the load voltage (5V) as a result that a high voltage is converted to a voltage close to the load voltage by the converter 21. Thus, it is possible to reduce the loss of voltage-converting efficiency of the apparatus as a whole and the heat-generation furthermore, improving the fuel consumption. Moreover, since the voltage drop through the series regulator 22 is small (2V=7−5), the heat generation is remarkably reduced to allow the series regulator 22 to be small-sized. In the modification, the intermediate voltage may be either 6V or any value from 8V to 11V alternatively.

According to the second embodiment, owing to the adoption of the intermediate voltage of 7V equal to a voltage for driving the general-purpose electronic control unit 7, there is no need to arrange special power lines between the power source part 4 and the electronic control units 7.

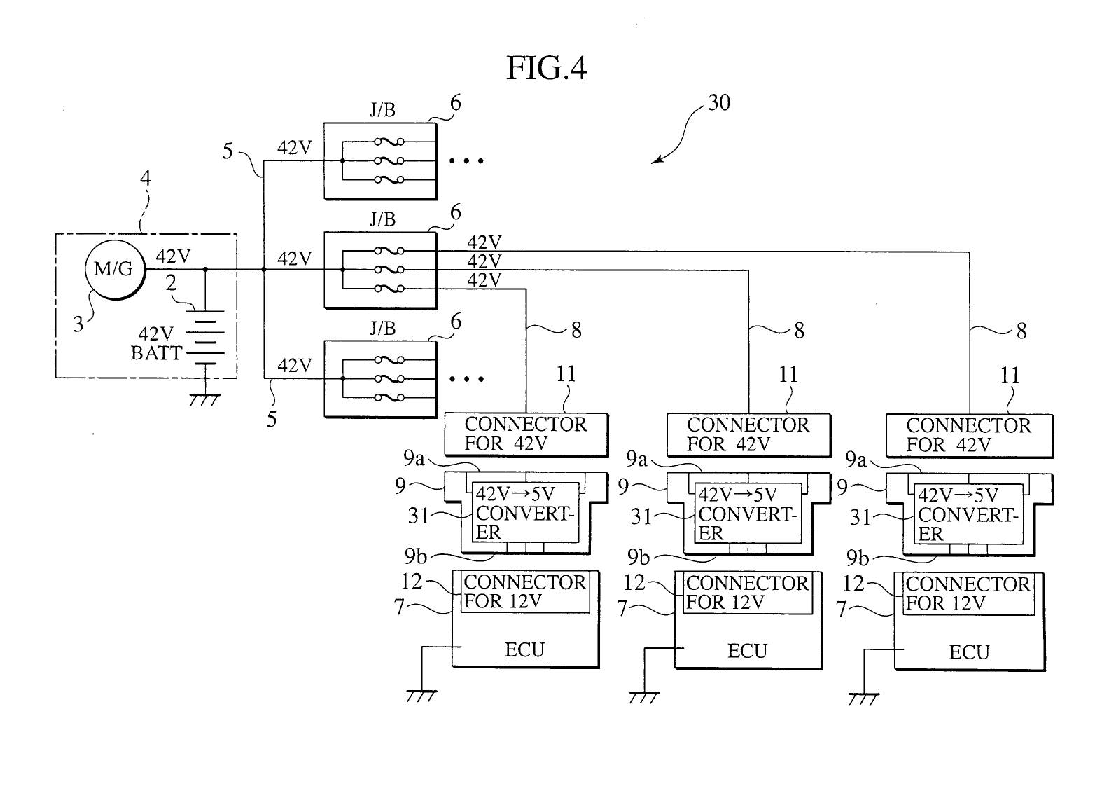

FIG. 4 is a circuit block diagram plan view of a power distributing apparatus in accordance with the third embodiment of the invention. As obvious from FIG. 4, the power distributing apparatus 30 of this embodiment differs from the same apparatus 1 of the first embodiment in that a built-in converter 41 of each intermediate connector 9 converts a high voltage of 42V of the power source part 4 to an intermediate voltage of 5V equal to the load voltage and the electronic control units 7 are respectively provided with no series regulator. Since the other constitutions of this embodiment are similar to those of the first embodiment, their overlapping descriptions are eliminated. Also in FIG. 4, elements identical to those of the first embodiment are indicated with the same reference numerals respectively, for their clearness.

Both effects and operations of the apparatus of this embodiment are similar to those of the first embodiment.

Again, owing to the establishment of the intermediate voltage equal to the load voltage (5V), there is no need to arrange a series regulator in each of the electronic control units 7.

According to the second embodiment, owing to the adoption of the intermediate voltage of 7V equal to a voltage for driving the general-purpose electronic control unit 7, there is no need to arrange special power lines between the power source part 4 and the electronic control units 7.

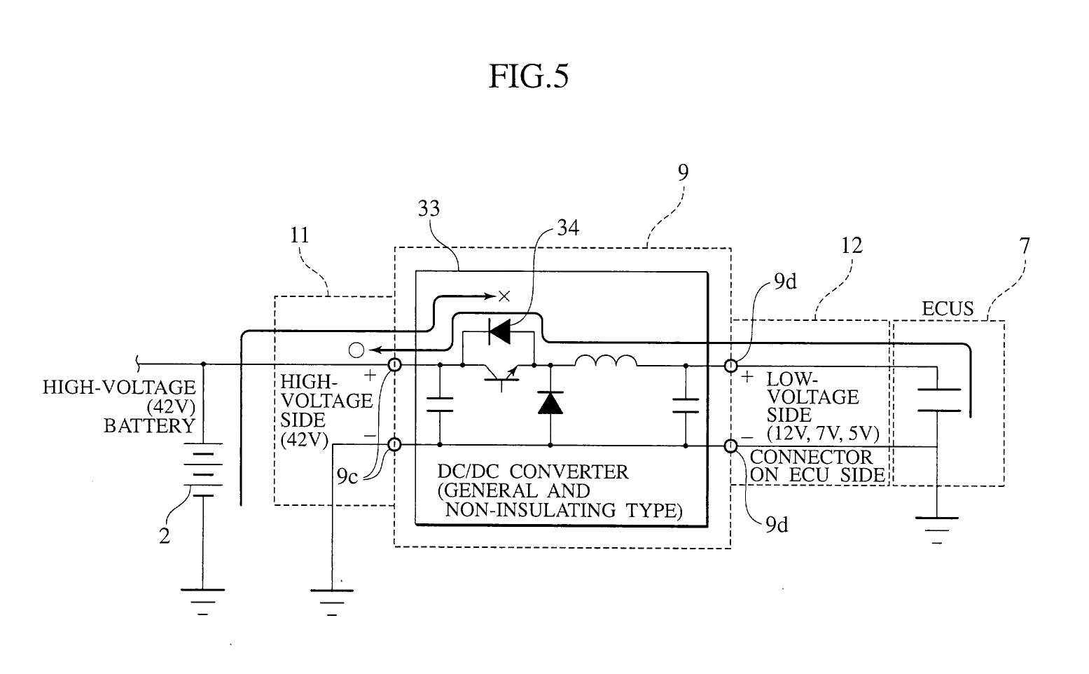

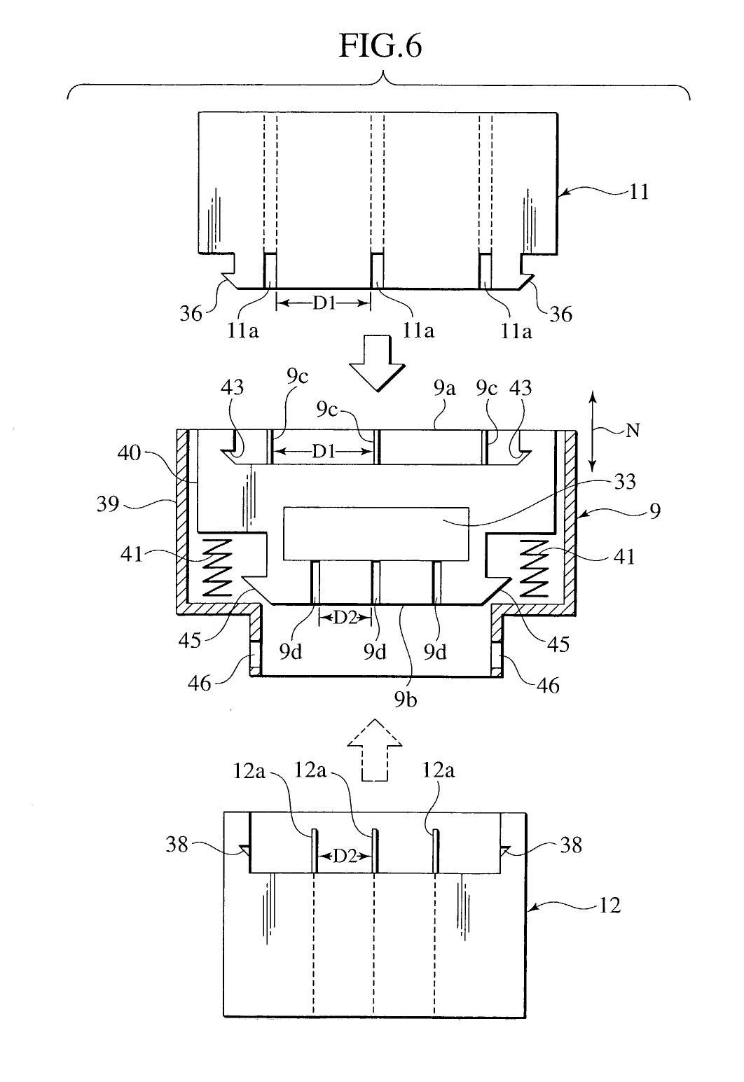

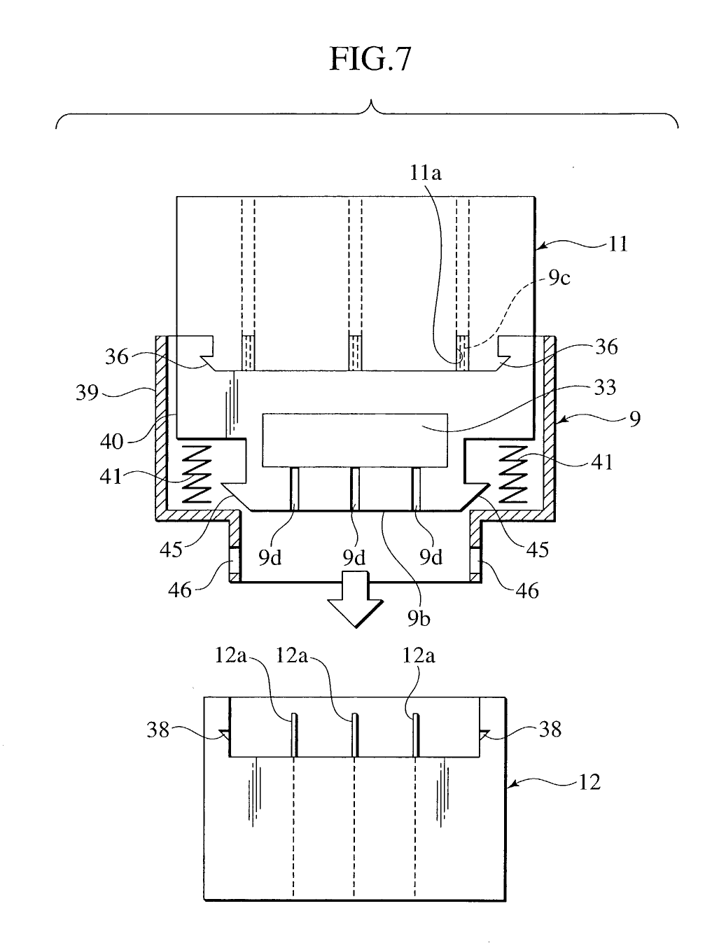

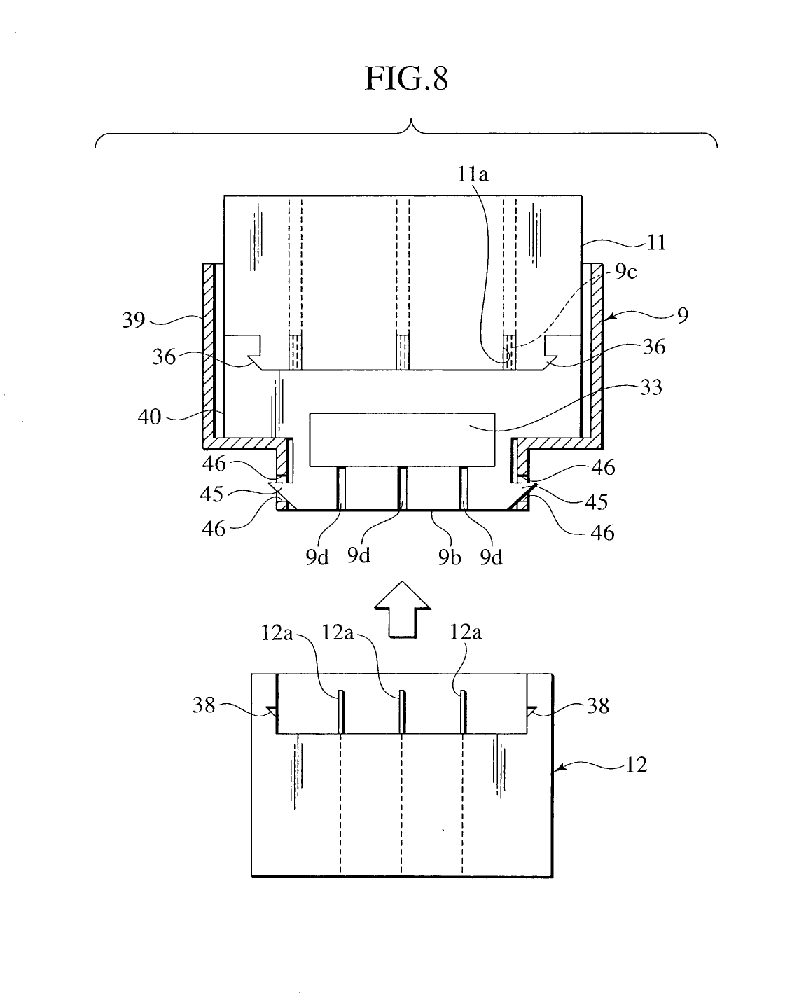

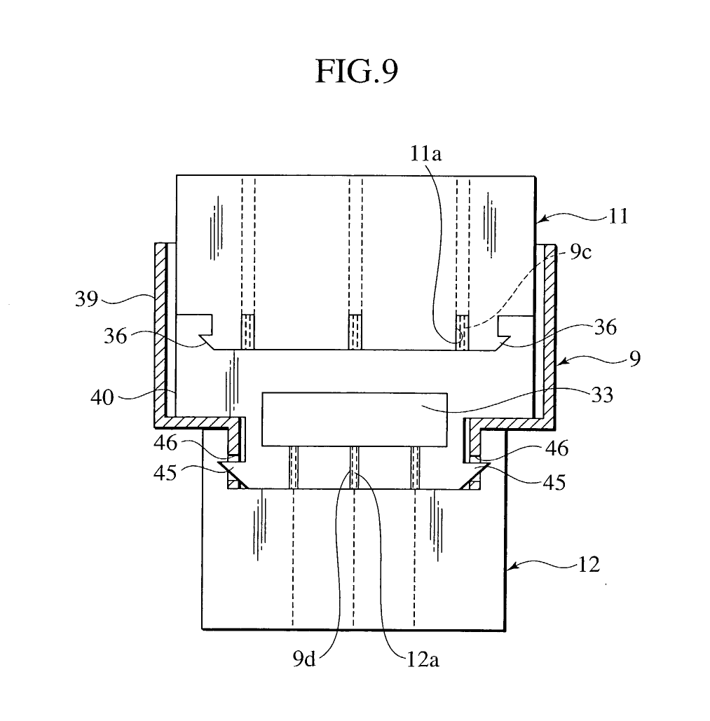

FIGS. 5 to 9 show a concrete embodiment of the intermediate connector 9, the power-line side connector 11 and the power-distributing side connector 12 both fitted to the intermediate connector 9. In these figures, FIG. 5 is a circuit diagram of the intermediate connector etc. FIG. 6 is a structural view of the intermediate connector, the power-line side connector and the power-distributing side connector before their integration. FIG. 7 is a structural view showing a condition in the middle of engaging the power-line side connector with the intermediate connector. FIG. 8 is a structural view showing a condition that the engagement between the power-line side connector and the intermediate connector has been completed and the engagement between the power-distributing side connector and the intermediate connector is not finished yet. FIG. 9 is a structural view showing a condition that the engagement among the power-line side connector, the power-distributing side connector and the intermediate connector has been completed.

As shown in FIG. 5, a built-in converter 33 of the intermediate connector 9 is a non-insulation type DC/DC (direct current) converter. In case of the adoption of this type converter, the power-distributing side connector 12 (output side) has to be fitted to the converter after the power-line side connector 11 (input side) has been fitted to the converter. To the contrary, if connecting the “output-side” connector (low voltage side: 12V, 7V or 5V) to the converter in advance of its connection with the “input-side” connector, the contact between the “input-side” terminals 9c and metals is in danger since a voltage on the output side is also applied to the terminals 9c (high-voltage side: 42V). Additionally, if connecting the converter with the “input-side” connector after the connection with the “output-side” connector and if the battery 2 of 42V has been connected to the terminals 9c (high-voltage side), then a short circuit is caused due to the presence of low voltage and 42V thereby to produce arcs dangerously. While, when the connection with the input-side connector (high-voltage side) precedes the connection with the output-side connector (low-voltage side), the safety in fitting operation can be ensured since no voltage is applied to the terminals 9d owing to the provision of a diode 34 in the converter 33.

Next, we describe the structures of the connectors 9, 11, 12 with reference to FIGS. 6 to 9. As shown in FIG. 6, the power-line side connector 11 is provided, on the side of a joint face thereof, with female terminals 11a. Further, the power-line side connector 11 has a pair of first engagement claws 36 formed on both sides of the joint face. On the other hand, the power-distributing side connector 12 is provided, on the side of a joint face thereof, with male terminals 12a. Further, the power-distributing side connector 12 has a pair of second engagement grooves 38 formed on both sides of the joint face.

The intermediate connector 9 has a connector-transferring part 40 disposed in an outer casing 40. The connector-transferring part 40 is capable of moving between a connector non-fitting position (see FIGS. 6 and 7) and another connector fitting position (see FIGS. 8 and 9), in a connector inserting/withdrawing direction N. Left and right springs 41 in pairs are interposed between the connector-transferring part 40 and the outer casing 39. By force of the springs 41, the connector-transferring part 40 is urged toward the connector non-fitting position. Further, the connector-transferring part 40 is provided, on the opposite sides, with an “input-side” connector part 9a for connection with the power-line side connector 11 and an “output-side” connector part 9b for connection with the power-distributing side connector 12. Male terminals 9c are arranged on the side of the joint face of the input-side connector part 9a. Further, the input-side connector part 9a has a pair of first engagement grooves 43 formed on both sides of the joint face. Similarly, female terminals 9d are arranged on the side of the joint face of the output-side connector part 9b. Further, the output-side connector part 9b has a pair of second engagement claws 45 formed on both sides of the joint face. The outer casing 39 is provided with case-side engagement grooves 46 for engagement with the second engagement claws 45 at the connector fitting position.

As mentioned before, both of the power-line side connectors 11 and the input connector part 9a of the intermediate connector 9 are provided as being connectors for 42V and the distance D1 between adjacent terminals 11a, 11a (and also 9c, 9c) is established to be relatively broad. On the other hand, both of the power-distributing side connectors 12 and the output connector part 9b of the intermediate connector 9 are provided as being connectors for 12V and the distance D2 between adjacent terminals 12a, 12a (and also 9d, 9d) is established to be relatively narrow.

Next, we describe the fitting operation among the connectors. As shown with arrow of FIG. 6, when the “joint-face” side of the power-line side connectors 11 is inserted into the input connector part 9a of the intermediate connector 9, the terminals 11a of the connector 11 are connected with the terminals 9c of the connector 9 and simultaneously, the first engagement claws 36 are engaged in the first engagement grooves 43 respectively.

From this situation, when the “joint-face” side of the power-line side connector 11 is further inserted into the input connector part 9a of the intermediate connector 9 as shown with arrow of FIG. 7, the connector-transferring part 40 moves toward the connector fitting position, in opposition to the spring force of the springs 41. Then, if the connector-transferring part 40 finally reaches the connector fitting position, then the second engagement claws 45 are engaged in the casing-side engagement grooves 46 as shown in FIG. 8, so that the connector-transferring part 40 is locked at the connector fitting position.

Next, as shown with arrow of FIG. 9, when the “joint-face” side of the power-distributing side connector 12 is inserted into the output connector part 9b of the intermediate connector 9, the terminals 12a of the connector 12 are connected with the terminals 9d of the connector 9 and simultaneously, the second engagement claws 45 are engaged in the second engagement grooves 38 respectively. In this way, the power-distributing side connector 12 is fitted to the intermediate connector 9.

While, as shown with imaginary arrow of FIG. 6, if it is required to fit the power-distributing side connector 12 to the intermediate connector 9 at first, it is impossible to fit the power-distributing side connector 12 to the intermediate connector 9 because the connector transferring part 40 is positioned at the non-fitting position.

As mentioned above, so far as the intermediate connector 9 is not connected with the power-line side connector 11, the connector 9 is brought into its non-connecting condition unable to connect with the power-distributing side connector 12. While, under condition that the intermediate connector 9 is connected with the power-line side connector 11, the connector 9 is brought into its connectable condition capable of connection with the power-distributing side connector 12. That is, since the power-distributing side connector 12 cannot be fitted to the intermediate connector 9 unless the engagement between the power-line side connector 11 and the intermediate connector 9 is completed, it is possible to prevent the occurrence of arcs etc. caused by short-circuit even when adopting general and non-insulating type converters as the converters 33, whereby the safety in operation can be ensured.

Although the power source part 4 has a high voltage of 42V in common with three embodiments mentioned above, the power source part 4 may be constructed to generate a different high voltage, for example, 288V, 144V. Then, if only the converters 13, 21, 31 in the intermediate connectors 9 convert such high voltages (288V, 144V) to the intermediate voltages (e.g. 12V, 7V, 5V) like the first to the third embodiments, it is possible to use the same electronic control units 7 as those of the embodiments. Note, in this case, it is necessary to change the “inter-terminal” distances D1 of the power-line side connector 11 and the input-side connector part 9a of the intermediate connector 9 in correspondence to the above high voltage.

It should be noted that, in the present circumstances, the mainstream of vehicles still resides in a vehicle having a power source part of 12V in the stream of transferring to vehicles of 42V. Further, an electric car, a hybrid car, etc. each adopts a “high-voltage” power source part of 288V. Therefore, the existing power distributing apparatus has been required to make the electronic control units 7 cope with a variety of power source parts mentioned above. Despite such a situation, if only altering respective designs of the power-line side connector 11 and the intermediate connector 9 so as to cope with various high voltages, then it is possible to establish the power distributing apparatus with ease and without changing the design of the electronic control unit.

Also noted, in the first and second embodiments, the series regulators 14 are constructed so as to convert an intermediate voltage of 12V or 7V to a load voltage of 5V In the modification, in case of the load voltage of 2.4V or 3.3V, the series regulators 14 will be constructed so as to convert the intermediate voltage to such a load voltage.

Again, it will be understood by those skilled in the art that the foregoing descriptions are nothing but one embodiment of the disclosed power distributing apparatus and the modifications. In addition to the above modifications, various changes and modifications may be made to the present invention without departing from the scope of the invention.

What is claimed is:

1. A power distributing apparatus comprising:
a power source part generating a power of a high voltage;
a plurality of power distributing parts to which the power source part supplies the power of the high voltage through respective power lines, each of the power distributing parts being adapted to supply a load with a load voltage;
a plurality of intermediate connectors through which the power lines from the power source part are connected with the power distributing parts respectively; and
a plurality of converters disposed in the intermediate connectors respectively thereby to each convert the high voltage into an intermediate voltage lower than the high voltage.

2. The power distributing apparatus as claimed in claim 1, wherein
the intermediate voltage is higher than the load voltage and the power distributing parts are respectively provided with series regulators each of which converts the intermediate voltage into the load voltage.

3. The power distributing apparatus as claimed in claim 2, wherein
the intermediate voltage higher than the load voltage is equal to a voltage that a general purpose low-voltage vehicle supplies through a power source part thereof.

4. The power distributing apparatus as claimed in claim 2, wherein
the intermediate voltage higher than the load voltage is equal to a voltage for driving a general purpose electronic control unit.

5. The power distributing apparatus as claimed in claim 1, wherein
the intermediate voltage is equal to the load voltage.

6. The power distributing apparatus as claimed in claim 1, further comprising a plurality of power-line side connectors which are connected with the power source part through the power lines and a plurality of power-distributing side connectors which are disposed in the power distributing parts respectively, wherein
a distance between adjacent terminals of each of the power-line side connectors and also between adjacent terminals on an input side of each of the intermediate connectors is larger than a distance between adjacent terminals of each of the power-distributing side connectors and also between adjacent terminals on an output side of each of the intermediate connectors.

7. The power distributing apparatus as claimed in claim 6, wherein
each of the intermediate connectors is provided with a mechanism which would make impossible to connect the corresponding intermediate connector with the corresponding power-distributing side connector unless the corresponding intermediate connector is connected with the corresponding power-line side connector.

8. The power distributing apparatus as claimed in claim 7, wherein
the mechanism includes a connector-transferring part which is movably disposed in the intermediate connector to be engageable with both of the power-line side connector and the power-distributing side connector and which is provided with engagement pieces which allow the intermediate connector to engage with the power-distributing side connector upon engagement of the connector-transferring part with the power-line side connector.

9. An intermediate connector disposed between a power source part of a power distributing apparatus, the power source part generating a power of a high voltage, and a power distributing part of the power distributing apparatus, the power distributing part being adapted to supply a load with a load voltage, the intermediate connector comprising:
a built-in converter for converting the high voltage of the power source part into an intermediate voltage lower than the high voltage.

10. The intermediate connector as claimed in claim 9, wherein
the power distributing apparatus further includes a power-line side connector which is connected with the power source part and a power-distributing side connector disposed in the power distributing part; and
a distance between adjacent terminals of the intermediate connector for connection with the power-line side connector is established larger than a distance between adjacent terminals of the intermediate connector for connection with the power-distributing side connector.

11. The intermediate connector as claimed in claim 10, further comprising a mechanism which would make impossible to connect with the power-distributing side connector unless the intermediate connector is connected with the power-line side connector.

12. The intermediate connector as claimed in claim 11, wherein
the mechanism includes a connector-transferring part which is movably disposed in the intermediate connector to be engageable with both of the power-line side connector and the power-distributing side connector and which is provided with engagement pieces which allow the intermediate connector to engage with the power-distributing side connector upon engagement of the connector-transferring part with the power-line side connector.
